(19) United States
(12) Patent Application Publication
(10) Pub. No.: US 2007/0102209 A1
(43) Pub. Date: May 10, 2007

(54) Hybrid drive for a tracked vehicle

(75) Inventor: Rolf Doebereiner, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: RENK Aktiengesellschaft, Augsburg (DE)

(21) Appl. No.: 11/494,985

(22) Filed: Jul. 28, 2006

(30) Foreign Application Priority Data
Jul. 30, 2005 (DE) 10 2005 035 824.1

(51) Int. Cl. B60K 1/00

(52) U.S. Cl. 180/65.4; 180/6.7

(57) ABSTRACT

A drive for a tracked vehicle with a drive shaft which drives two track drive wheels, and at least one differential gear arrangement which can superimpose a steering rotational speed of a steering drive on at least one track drive wheel is disclosed. The drive shaft has a drive connection to at least one electric machine which can be operated as a generator or electric motor and the output shafts of an internal combustion engine and of the at least one electric machine can be coupled to one another by means of a variable ratio gear unit.

This application claims the priority of German Patent Document No. 10 2005 035 824.1, filed Jul. 30, 2005, the disclosure of which is expressly incorporated by reference herein.

### BACKGROUND AND SUMMARY OF THE INVENTION

The invention relates to a drive for a tracked vehicle.

What are referred to as hybrid drives are generally known for driving passenger motor vehicles. In the search for possible ways of saving fuel, vehicles with electric motors as the locomotive drive have been developed. The electric current for the locomotive drive is supplied here by a generator which is driven by an internal combustion engine. Concepts are known in which all of the mechanical energy of the internal combustion engine is converted into electrical energy and is converted back again into mechanical movement energy by means of an electric motor. Other concepts use part of the mechanical energy of the internal combustion engine directly to drive the vehicle and convert the remaining part into electrical energy. The electrical energy can, on the one hand, be used for the drive by means of an electric motor or can be stored in a battery. The vehicle can then draw drive power for the electric motor from the battery independently of the internal combustion engine.

German Patent Document No. DE 37 28 171 C2 discloses an electro-mechanical drive system for a full track vehicle. The power of an internal combustion engine is converted into electrical energy by means of a generator and is used again as mechanical drive power by means of electric motors. For this purpose, an electric motor is provided which drives a central shaft which is connected in each case to the two track drive wheels via a differential gear arrangement. In order to steer the tracked vehicle, an electric steering motor is provided which provides drive into the differential gear arrangements in the opposite direction via a zero shaft.

German Patent Document No. DE 10 2004 009 030, which was not published before the priority date of the present document, discloses a parallel hybrid drive for tracked vehicles, in which drive the electric motor which is embodied, for example, as a starter/generator, can additionally be used, when necessary, for the locomotive drive. In such arrangements the power of the electric motor is often significantly smaller than that of the internal combustion engine. It is also referred to as a mild hybrid layout.

The object of the invention is to improve the known hybrid drive for a tracked vehicle.

The supply of electrical power to the loads can advantageously be ensured in a tracked vehicle by means of a drive according to the invention. In military vehicles, for example combat tanks, it is possible, for example to supply current to electrical weapons.

By supplying electrical energy from an energy accumulator it is possible, with a drive according to the invention, to advantageously increase the maximum speed of a tracked vehicle compared to a conventionally driven tracked vehicle. Likewise, the largest possible acceleration can advantageously be increased and noiseless crawl mode travel is also possible with a tracked vehicle according to the invention.

When braking, energy can advantageously be fed back, via the electric machines, into batteries or other electrical, mechanical or hydraulic energy accumulators.

When a clutch is closed, a tracked vehicle according to the invention can advantageously be cranked. In this context, the electrical energy required for the starting process can be generated by the electric machines.

In a drive according to the invention, a hybrid unit assumes the function of a torque converter of conventional automatic transmissions so that the change speed gearbox of the vehicle can therefore particularly advantageously be embodied without a torque converter.

Since the rotational speed of the internal combustion engine is not directly coupled to the rotational speed of the gearbox by virtue of the hybrid unit of the drive according to the invention, it is possible to operate the internal combustion engine in the region of its best efficiency or on the trajectory of its best efficiency. In this context, it is possible to advantageously dimension the internal combustion engine with respect to specific load points which have optimized consumption and emission.

Further features and advantages emerge from the description.

### BRIEF DESCRIPTION OF THE DRAWINGS

The invention will be explained in more detail below with reference to the associated schematic drawings, in which:

FIG. 1 shows a first exemplary embodiment of the drive according to the invention; and

FIG. 2 illustrates a further inventive embodiment of the drive.

### DETAILED DESCRIPTION OF THE DRAWINGS

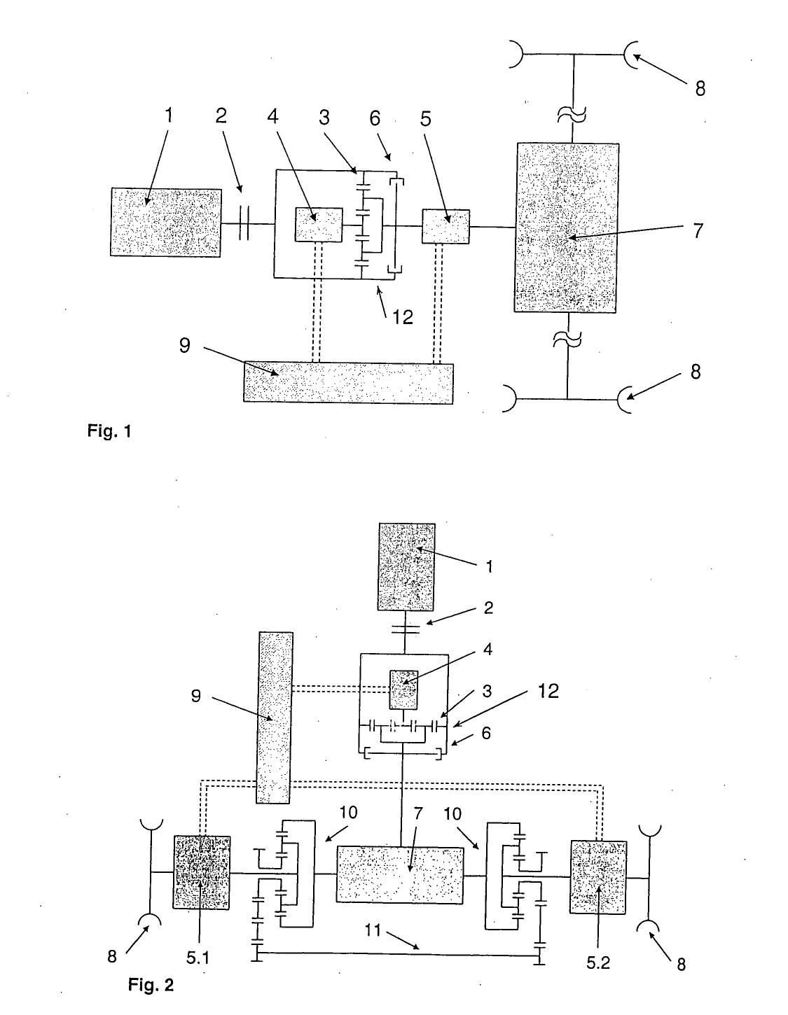

FIG. 1 shows an internal combustion engine 1 which is connected to the ring gear 3 of what is referred to as a hybrid unit 12 in such a way that it can be disengaged by means of a clutch 2, the hybrid unit 12 acting as a variable ratio gear unit. The hybrid unit 12 is formed by a planetary gear mechanism, with a first electric motor 4 being connected to the sun wheel and a further electric motor 5 being connected to the output web or planetary carrier of the planetary gear mechanism. Electric machines, which can optionally be operated as electric motors or as generators, are provided as electric motors 4, 5. Electric machines 4, 5 are subsequently referred to as a generator or electric motor, depending on their respective mode of operation.

Instead of an internal combustion engine 1, a gas turbine or some other thermal engine can be provided to generate mechanical power.

The thermal engine and the electric machines can also be connected to other input elements of the planetary gear mechanism apart from those described above.

The first electric machine 4 or/and the further electric machine 5 can charge, in the generator mode, the energy accumulators provided in the vehicle. These may be electrical energy accumulators 9 such as, for example, batteries and/or mechanical energy accumulators such as, for example, flywheel storage devices.

The hybrid unit 12 can be locked with a converter lockup clutch 6. The hybrid unit 12 is connected to a change speed gear unit 7 in which a steering variable ratio gear unit and at least one vehicle brake are integrated. The steering variable ratio gear unit is composed of at least one differential gear arrangement which can superimpose a steering rotational speed of a steering drive on at least one track drive wheel so that the tracks generate different speeds on the two sides of the vehicle and the vehicle turns a corner.

The track wheels 8 are connected directly or via intermediate gears to the change speed gear unit 7. A mechanical brake can also be integrated here.

When the clutch 2 is closed, the internal combustion engine 1 can be started by means of the first electric motor 4. The electric machine 5 is stationary at this time. The clutch 2 can preferably also be shifted under load.

When the vehicle is stationary and the internal combustion engine 1 is running with the clutch 2 closed, the first electric machine 4 rotates, in the generator mode, at the rotational speed which results from the transmission ratio of the planetary gear mechanism. The other electric machine 5 is stationary and the required gear speed is engaged in the change speed gear unit 7. In order to drive off, the first electric motor 4 is slowed down while the torque remains the same and the other electric motor 5 begins to rotate in a corresponding way. The vehicle drives off. At the same time, the energy generated by the first electric motor 4 is used to operate the other electric motor 5. This permits optimum conversion of the power made available by the internal combustion engine. The hybrid unit 12 here assumes the function of the torque converter of conventional automatic transmissions. The change speed gear unit 7 can therefore also advantageously be embodied without a torque converter.

In order to increase the acceleration and the maximum speed, the electric motors 4 and 5 which are fed from an electrical energy accumulator 9 can supply further drive power to the drive in addition to the internal combustion engine 1 when the clutch 2 is closed.

The hybrid unit 12 can be locked by means of a converter lockup clutch 6, i.e., the ring gear 3 and the planetary gear mechanism are rigidly coupled to one another and all the shafts of the variable ratio gear unit 12 can only then turn together. The electric motors 4 and 5 then rotate at the rotational speed of the internal combustion engine and can be operated in synchronism as in parallel hybrid drives.

During the load shifting processes in the change speed gear unit 7, the converter lockup clutch 6 can be opened. When the rotational speed of the internal combustion engine 1 is unchanged, the engagement rotational speed at the change speed gear unit 7, which corresponds to the connected through new gear speed, can be advantageously set quickly by means of the electric motors 4 and 5. There is thus a longer time period available for the adaptation of the rotational speed of the internal combustion engine 1.

The electric machines 4 and 5 are preferably configured in such a way that in the generator mode they ensure the power supply to the vehicle and to the installed electric loads such as, for example, also electric weapons in the case of combat tanks.

When braking occurs, the movement energy of the tracked vehicle can advantageously be converted into electrical energy by means of the generators 4 and/or 5, and the electrical energy accumulator 9 can be charged. It is also advantageous to provide further mechanical and/or hydraulic energy accumulators which can be charged by the movement energy of the vehicle when braking occurs, when the vehicle coasts to a standstill or when it travels downhill.

When the clutch 2 is closed, the internal combustion engine 1 of a tracked vehicle according to the invention can advantageously be cranked. The electrical energy which is required for the starting process can be generated here by the generators 4 and/or 5. The converter lockup clutch 6 is closed at this time.

Since the rotational speed of the internal combustion engine is not coupled directly to the rotational speed of the gearbox 7 it is possible to operate the internal combustion engine in the region of its best efficiency or on the trajectory of its best efficiency. In this context, it is advantageously possible to dimension the internal combustion engine to specific load points which have optimum consumption and emission.

The electric machines 4 and 5 are preferably configured in such a way that an internal combustion engine with less power than would be required for the same driving powers in a conventional vehicle can be integrated into the hybrid vehicle.

The known advantage of diesel/electric drives of being able to position the internal combustion engine with a generator in any desired position irrespective of the arrangement of the gearbox can be implemented with the present invention by virtue of the fact that the internal combustion engine or engines are connected to the drive by means of cardan shafts. Similarly, gas turbines may be provided instead of internal combustion engines.

Owing to the non-stationary operation when travelling, the electric motors 4 and 5 can be made capable of coping with overloading, and thus be advantageously small in size.

In a further embodiment variant of the invention, the function of the other electric machine 5 is integrated into the output axis of the change speed gear unit 7. Its function is assumed by two electric motors 5.1 and 5.2 which are also used for steering. When steering, a different rotational speed is set at the electric motors 5.1 and 5.2. The regenerative steering principle with power flux from the side on the inside of a bend to the side on the outside of a bend is ensured by means of the steering differentials 10 and a zero shaft 11 which connects them.

In a further embodiment of the invention, an electrical energy accumulator 9 is not required because one of the electric machines 4 or 5 operates as a generator. The electrical energy which is generated in this way is passed on directly to the second electric machine which operates as an electric motor and is converted into rotational speed and torque. All the electric motors can be operated from a controlled electric intermediate circuit via power electronics.

List of reference numerals:
1 Internal combustion engine/gas turbine
2 Clutch
3 Ring gear of the hybrid unit
4 Electric motor 1 of the hybrid unit
5 Electric motor 2 of the hybrid unit
5.1 Electric motor 2 of the hybrid unit, left hand
5.2 Electric motor 2 of the hybrid unit, right hand
6 Converter lockup clutch of the hybrid unit
7 Gearbox
8 Track wheel
9 Electrical energy accumulator
10 Steering differential
11 Zero shaft
12 Hybrid unit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive for a tracked vehicle with a drive shaft which drives two track drive wheels, and at least one differential gear arrangement which superimposes a steering rotational speed of a steering drive on at least one track drive wheel, the drive shaft having a drive connection to at least one electric machine which is operable as a generator or an electric motor, wherein an output shaft of an internal combustion engine and an output shaft of the at least one electric machine are coupled to one another by means of a variable ratio gear unit.

2. The drive according to claim 1, wherein the output shaft of the internal combustion engine is coupled to the variable ratio gear unit by means of a ring gear, a first electric machine is coupled to the variable ratio gear unit by means of a sun wheel, and wherein a second electric machine is connected to a planetary carrier of the variable ratio gear unit and to an input shaft of a change speed gear unit.

3. The drive according to claim 1, wherein the output shaft of the internal combustion engine is coupled to the variable ratio gear unit by means of a ring gear, a first electric machine is coupled to the variable ratio gear unit by means of a sun wheel, a planetary carrier of the variable ratio gear unit is connected to an input shaft of a change speed gear unit, and wherein a second and a third electric machine, each of which has a drive connection to the change speed gear unit by means of the differential gear arrangement, is assigned to each track drive wheel.

4. The drive according to claim 1, wherein the output shaft of the internal combustion engine is coupled to the variable ratio gear unit, or decoupled from it, by means of a clutch which is shiftable under load.

5. The drive according to claim 1, wherein the variable ratio gear unit is lockable by means of a converter lockup clutch.

6. The drive according to claim 1, further comprising at least one electrical energy accumulator which is chargeable by the electric machine when operating as the generator.

7. The drive according to claim 1, wherein the electric machine is operable as an electric brake and converts a movement energy of the tracked vehicle, as it coasts to a standstill or when it travels downhill, into electrical energy with which an electrical energy accumulator is chargeable.

8. A drive for a tracked vehicle, comprising:
an internal combustion engine;
a hybrid unit coupled to the internal combustion engine; and
a change speed gear unit coupled to the hybrid unit.

9. The drive according to claim 8, wherein the hybrid unit is a variable ratio gear unit.

10. The drive according to claim 8, wherein the hybrid unit includes a first electric machine operable as a generator and a second electric machine operable as an electric motor.

11. The drive according to claim 10, wherein the first electric machine supplies electrical energy to the second electric machine.

12. The drive according to claim 10, wherein the first electric machine is driven by the internal combustion engine and wherein the second electric machine drives the change speed gear unit.

13. The drive according to claim 10, wherein the first electric machine charges an energy accumulator coupled to the first electric machine.

14. The drive according to claim 10, wherein the first electric machine supplies electrical energy to start the internal combustion engine.
